(19) United States
(12) Patent Application Publication
(10) Pub. No.: US 2022/0086697 A1
(43) Pub. Date: Mar. 17, 2022

(54) AN ACCESS NETWORK NODE

(71) Applicant: NEC Corporation, Minato-ku, Tokyo (JP)

(72) Inventors: Toshiyuki TAMURA, Tokyo (JP); Linghang FAN, Woking Surrey (GB); Iskren IANEV, Lower Earley (GB)

(73) Assignee: NEC Corporation, Minato-ku, Tokyo (JP)

(21) Appl. No.: 17/414,783

(22) PCT Filed: Dec. 13, 2019
(86) PCT No.: PCT/JP2019/048867

§ 371 Date: Jun. 16, 2021

(30) Foreign Application Priority Data
Jan. 9, 2019 (EP) 19151053.6

(51) Int. Cl. H04W 28/24

(52) U.S. Cl. CPC H04W 28/24

(57) ABSTRACT

The present disclosure is concerned with enhancements to the QoS notification control scheme. With a better understanding on why QoS target(s) cannot be fulfilled, the PCF/AF can take proper action based on the obtained QoS information and data.

This application is a National Stage Entry of PCT/JP2019/048867 filed on Dec. 13, 2019, which claims priority from European Patent Application 19151053.6 filed on Jan. 9, 2019, the contents of all of which are incorporated herein by reference, in their entirety.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to improvements relating to QoS notification control in the so-called ‘5G’ (or ‘Next Generation’) systems.

The following aspects aim to enhance the QoS notification control scheme. With a better understanding on why QoS target(s) cannot be fulfilled, the PCF/AF can take proper action based on the obtained QoS information and data.

### BACKGROUND ART

### Abbreviations

3GPP 3rd Generation Partnership Project
5GC 5G Core Network
5GS 5G System
5G-AN 5G Access Network
AF Application Function
AMBR Aggregate Maximum Bit Rate
AMF Access and Mobility Management Function
AN Access Network
CM-CONNECTED Connection Management-CONNECTED State
CM-IDLE Connection Management-IDLE State
DL Downlink
DNN Data Network Name
eNB evolved NodeB
EPS Evolved Packet System
E-UTRA Evolved Universal Terrestrial Radio Access
GBR Guaranteed Bit Rate
GFBR Guaranteed Flow Bit Rate
gNB next generation Node B
N1 Reference point between the UE and the Access and Mobility Management function
N2 Reference point between the (R)AN and the Access and Mobility Management function
NAS Non-Access-Stratum
NF Network Function
NG Next Generation
NG-RAN Next Generation-Radio Access Network
OAM Operations, Administration and Maintenance
OTT Over the Top
PCF Policy Control Function
PDB Packet Delay Budget
PDU Protocol Data Unit
PER Packet Error Rate
QFI QoS Flow Identifier
QoS Quality of Service
RAN Radio Access Network
RRC Radio Resource Control
SM Session Management
SMF Session Management Function
TA Tracking Area
UE User Equipment
UL Uplink
UPF User Plane Function
V2X Vehicle-to-everything

The 3GPP Working Groups are currently defining the 5G system and the 3GPP TSG SA WG2 (SA2) is specifying the system architecture and procedures for the 5G system. Within SA2, a study item “Study on architecture enhancements for EPS and 5G System to support advanced V2X services” (eV2X) has been created to study requirements and key issues of V2X services for 5G, and the results of this study has been documented in a technical report TR 23.786 V1.0.0.

Recently, new study has been proposed in SA2 to investigate how to perform QoS Support for eV2X over Uu interface in TR23.786 V1.0.0.

### SUMMARY OF INVENTION

### Technical Problem

According to current specification TS23.501 [1] and 23.502 [2], notification control is for GBR only. This concept has been extended to PDB and PER in the V2X study item During 3GPP SA2 meeting in November 2019.

The V2X study item also agreed that “In addition to notifying the V2X AF that the QoS targets cannot be fulfilled, the NG-RAN may also indicate the currently ‘QoS requirements that are guaranteed’ (GFBR, PDB and/or PER), so that the V2X application can take this information into account”.

Even a RAN can inform core network that the “QoS targets cannot be fulfilled” and currently ‘QoS requirements that are guaranteed’, there are at least one of the following problems:
Core network and AF still don't know how big is the difference between the current QoS measurements reading and the QoS target.
Core network and AF don't have the information on why QoS target(s) cannot be fulfilled.
If the notification control is triggered, the PDU session will always be released, no matter what QoS measurements are and what the reason to trigger the notification control is.

### Solution to Problem

According to an aspect of the present disclosure, an access network node includes: means for transmitting, to a session management function node, a notification message including information indicating that at least one Quality of Service, QoS, target for a Protocol Data Unit, PDU, session cannot be fulfilled; and means for receiving, from the session management function node, information indicating at least one alternative QoS information.

According to another aspect of the present disclosure, a session management function node includes: means for receiving, from an access network node, a notification message including information indicating that at least one Quality of Service, QoS, target for a Protocol Data Unit, PDU, session cannot be fulfilled; and means for transmitting, to the access network node, information indicating at least one alternative QoS information.

According to another aspect of the present disclosure, a policy control function node includes: means for receiving, from a session management function node, a notification message including information indicating that at least one Quality of Service, QoS, target for a Protocol Data Unit, PDU, session cannot be fulfilled; and means for transmitting, to the session management function node, a new Policy and Charging Control, PCC, rule including at least updated policy information.

According to another aspect of the present disclosure, a method for an access network node, includes: transmitting, to a session management function node, a notification message including information indicating that at least one Quality of Service, QoS, target for a Protocol Data Unit, PDU, session cannot be fulfilled; and receiving, from the session management function node, information indicating at least one alternative QoS information.

According to another aspect of the present disclosure, a method for a session management function node, comprising: receiving, from an access network node, a notification message including information indicating that at least one Quality of Service, QoS, target for a Protocol Data Unit, PDU, session cannot be fulfilled; and transmitting, to the access network node, information indicating at least one alternative QoS information.

According to another aspect of the present disclosure, a method for a policy control function node, comprising: receiving, from a session management function node, a notification message including information indicating that at least one Quality of Service, QoS, target for a Protocol Data Unit, PDU, session cannot be fulfilled; and transmitting, to the session management function node, a new Policy and Charging Control, PCC, rule including at least updated policy information.

### Advantageous Effects of Invention

In certain aspects, an access network node, a session management function node, a policy control function node a method for an access network node, a method for a session management function node, and a method for a policy control function node may provide a technology for solving the problems as described above.

### BRIEF DESCRIPTION OF DRAWINGS

FIG. 1 demonstrates an exemplary procedure for enhanced QoS notification control, in which the PCF makes decision.

FIG. 2 demonstrates an exemplary procedure for enhanced QoS notification control, in which the PCF makes decision.

FIG. 3 demonstrates an exemplary procedure for the enhanced QoS notification control, in which the AF makes decision.

FIG. 4 demonstrates an exemplary procedure for the enhanced QoS notification control based on the information on the reason why the QoS target(s) cannot be fulfilled, in which the AF makes decision.

FIG. 5 schematically illustrates a mobile telecommunication system.

FIG. 6 is a block diagram illustrating, in more detail, the main components of the UE.

FIG. 7 is a block diagram illustrating, in more detail, the main components of an exemplary (R)AN node.

FIG. 8 is a block diagram illustrating, in more detail, the main components of a generic core network node.

### DESCRIPTION OF EMBODIMENTS

In order to address the aforementioned problems, a solution with some aspects will be proposed.

There are four aspects discussed in this document:
Aspect 1: Enhanced QoS Notification Control (Indicating the difference between the current QoS measurement(s) and the QoS target(s))—PCF makes decision
Aspect 2: Enhanced QoS Notification Control (Indicating the reason why the QoS target(s) cannot be fulfilled)—PCF makes decision
Aspect 3: Enhanced QoS notification control (Indicating the difference between the current QoS measurement(s) and the QoS target(s))—AF makes decision
Aspect 4: Enhanced QoS notification control (Indicating the reason why the QoS target(s) cannot be fulfilled)—AF makes decision

The main advantage of the present application is that the RAN provides an associated information to the core network on why the notification control is triggered. With the associated information, the core network can take an appropriate action.

One possible action of the core network is the update of a new QoS setting for a PDU session appropriately in case that a requested QoS cannot be fulfilled in the RAN. In this way, a lower QoS is accepted and the PDU session can continue.

Another possible action for the core network is to release the PDU session by referring to the associated information.

Additionally, the PDU session modification procedure to be taken after the RAN notification always gets successful since the core network understands the RAN situation in advance.

Aspect 1: Enhanced QoS Notification Control (Indicating the difference between the current QoS measurement(s) and the QoS target(s))—PCF 740 makes decision

The main idea of this aspect is to indicate the difference between the current QoS measurement(s) and the QoS target(s). In this aspect, the PCF 740 makes decision.

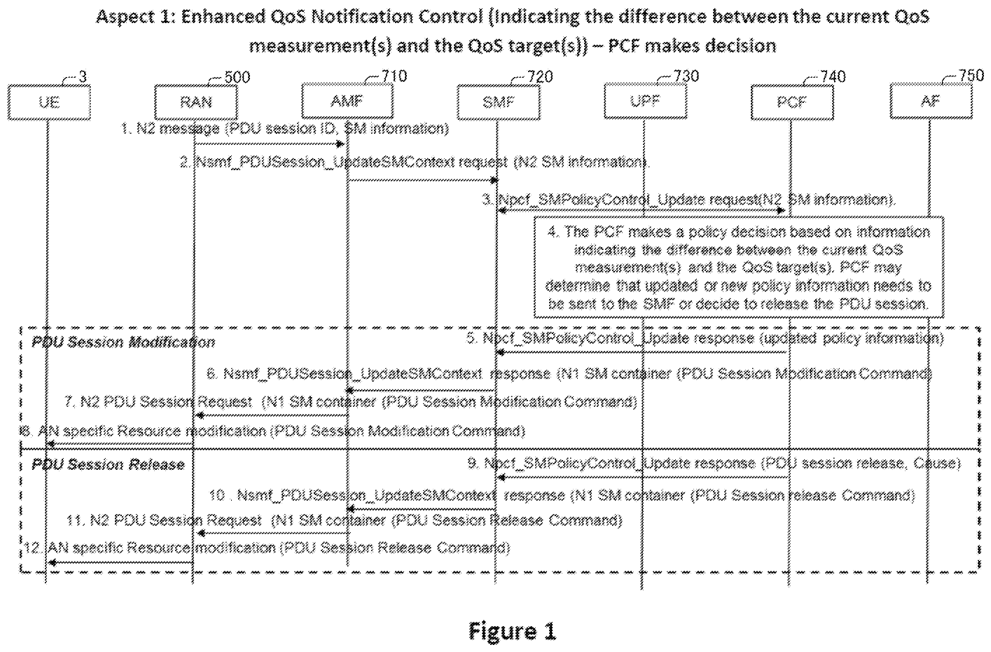

FIG. 1 demonstrates an exemplary procedure for enhanced QoS notification control (indicates the difference between the current QoS measurement(s) and the QoS target(s)), in which the PCF 740 makes decision. The new parameter(s) (e.g., information indicating the difference between the current QoS measurement(s) and the QoS target(s)), which are not defined in [1] and [2], are introduced for reporting QoS notification control related information to the network.

Step 1. In a case where one or more QoS target(s) for a PDU session cannot be fulfilled, the RAN 500 sends the AMF 710 a N2 message (PDU Session ID, N2 SM information) when the RAN 500 decides the QoS target(s) of a QoS Flow for the PDU session cannot be fulfilled. The N2 SM information includes the QFI (QoS Flow Identifier), indication(s) that the QoS target(s) for that QoS Flow cannot be fulfilled, and information indicating the difference between the current QoS measurement(s) and the QoS target(s). In some aspects, the N2 SM information may include at least one of the current QoS measurement of these QoS target(s) for that QoS Flow whose QoS target(s) cannot be fulfilled, indication(s) that the QoS target(s) for that QoS Flow are guaranteed, the current QoS measurement(s) of the QoS target(s) for that QoS Flow whose QoS target(s) are guaranteed. It is noted that new parameters are added in a N2 SM information message in the notification control to allow the network to know which QoS target(s) can be met and which QoS target(s) cannot be met, and how far is the difference between current QoS measurement(s) and QoS target(s).

In addition, The N2 SM information may include proposed QoS target information. The proposed QoS target information is set by the RAN 500 to offer an acceptable QoS target to the network. For example, the proposed Guaranteed Flow Bit Rate (GFBR) for DL indicates that a maximum rate of the GFBR for DL that the RAN 500 can accept for the PDU session, or for another example, the proposed Guaranteed Flow Bit Rate (GFBR) for UL indicates that a maximum rate of the GFBR for UL that the RAN 500 can accept for the PDU session. The proposed QoS target information can be used by the network to make a decision on a new QoS target for the PDU session. Since the RAN 500 guarantees to accept the new QoS target as long as the new QoS target is set less than the one indicated by the proposed QoS target, the following PDU session modification procedure, i.e., step 7 and step 8, has a good chance to be successful. With a successful PDU session modification procedure, the 5GS can continue to provide an application services, ex. V2X application service, with a new QoS setting.

Step 2. The AMF 710 invokes the Nsmf_PDUSession_UpdateSMContext request procedure or any other service procedure or sending a message for providing the SMF 720 the N2 SM information. The N2 SM information may be received from the RAN 500 in step 1.

Step 3. The SMF 720 invokes the Npcf_SMPolicyControl_Update request procedure or any other service procedure or sending a message for requesting the PCF 740 to update (by the Npcf_SMPolicyControl_Update request procedure) the SM Policy Association and providing N2 SM information. The N2 SM information may be the N2 SM information received from the AMF 710 in step 2.

Step 4. The PCF 740 makes a policy decision based on the information indicating the difference between the current QoS measurement(s) and the QoS target(s) included in the N2 SM information. The PCF 740 may determine that updated or new policy information needs to be sent to the SMF 720 or decide to release the PDU session. For example, if the QoS measurement(s) indicate jitter is high and delay is within budget, the PCF 740 may instruct the UE 3 to change its buffer size, and may determine that updated or new policy information needs to be sent to the SMF 720. If the QoS measurement(s) indicate the radio signal is not good, or the QoS measurement(s) indicate PER is high but delay is on target, the network may transmit redundant packets. If the reason why QoS target(s) cannot be fulfilled is “overload”, and the QoS measurement(s) indicate delay and PER are high, the PCF 740 may instruct the UE 3 to switch the currently used application/service (e.g., video streaming) by the user of the UE 3 to the preferred version of the application/service that has lower QoS requirements (e.g., lower resolution version), and may determine that updated or new policy information needs to be sent to the SMF 720. The proposed QoS target information can be taken into account by the PCF 740 for a policy decision.

In some aspects, if an event which the AF 750 has subscribed to corresponds to the report from the SMF 720, the PCF 740 invokes the Npcf_PolicyAuthorization_Notify procedure or any other service procedure or sending a message for reporting the event to the AF 750. New “QoS notification control event notification” is the procedure that the PCF 740 informs the AF 750 by using a Npcf_PolicyAuthorization_Notify message. The QoS notification control event notification may include timestamp(s) of the event and other N2 SM information. In this case, the AF 750 reacts based on information indicating the difference between the current QoS measurement(s) and the QoS target(s) and may request the UE 3 to change according to current QoS measurement. If the reason why QoS target(s) cannot be fulfilled is overload, and the QoS measurement(s) indicate that delay and PER are high, the V2X AF may instruct the UE 3 to switch the currently used application to the preferred version of the application that has lower QoS requirements (e.g., lower level of V2X automation). In this case, the AF 750 may invoke a Npcf_PolicyAuthorization update procedure or any other service procedure or sending a message for requesting the PCF 740 to change policy.

If PCF's decision is to invoke a PDU session modification procedure, it will carry on Step 5 to Step 8 (where the procedure ends).

If PCF's decision is to invoke a PDU session release procedure, it will carry on Step 9 to Step 12 (i.e., steps 5 to 8 are omitted).

Step 5. [Conditional] The PCF 740 invokes a Npcf_SMPolicyControl_Update response procedure or any other service procedure or sending a message for providing updated policy information about the PDU Session.

Step 6. [Conditional] The SMF 720 responds to the AMF 710 by invoking a Nsmf_PDUSession_UpdateSMContext response procedure or any other service procedure or sending a message for providing the N2 SM information to the RAN 500 and the PDU Session Modification Command to the UE 3. The N2 SM information includes a PDU Session ID, QFI(s), QoS Profile(s), and a Session-AMBR. The N1 SM container (PDU Session Modification Command) includes a PDU Session ID, QoS rule(s), QoS rule operation, QoS Flow level QoS parameters if needed for the QoS Flow(s) associated with the QoS rule(s), and Session-AMBR.

Step 7. [Conditional] The AMF 710 sends a N2 PDU Session Request Message with N2 SM information received from the SMF 720 and a NAS message, to the (R)AN 500. The NAS message includes a PDU Session ID, and a N1 SM container (PDU Session Modification Command).

Step 8. [Conditional] The (R)AN 500 may issue the AN specific signalling exchange (AN specific Resource modification) with the UE 3 on the resource modification (for example, by using the PDU Session Modification Command).

Step 9. [Conditional] The PCF 740 invokes a Npcf_SMPolicyControl_Update response procedure or any other service procedure or sending a message for requesting the release of the PDU Session with a Cause. The Cause is the associated information, which may be proposed QoS target information cannot be accepted or any other information related to the release of the PDU Session.

Step 10. [Conditional] The SMF 720 responds to the AMF 710 by invoking a Nsmf_PDUSession_UpdateSMContext response procedure or any other service procedure or sending a message for providing the N2 SM information to the RAN 500 and the PDU Session Release Command to the UE 3.

Step 11. [Conditional] The AMF 710 sends a N2 Resource Release request (N2 PDU Session Request) Message with N2 SM information received from the SMF 720 and a NAS message, to the (R)AN 500. The NAS message includes a PDU Session ID, and a N1 SM container (PDU Session Release Command).

Step 12. [Conditional] The (R)AN 500 may issue the AN specific signalling exchange (AN specific Resource modification) with the UE 3 to release the corresponding AN resources (for example, by using the PDU Session Release Command).

In this aspect, the PCF 740/AF 750 can have a better understanding the difference between the current QoS measurement(s) and the QoS target(s). As its result, the PCF 740/AF 750 can take proper action based on the obtained QoS information and data. Another benefit of this aspect is that if the notification control is triggered, the PDU session can be modified instead of being released, if the PCF 740/AF 750 decides to change the QoS setting.

Aspect 2: Enhanced QoS Notification Control (Indicating the reason why the QoS target(s) cannot be fulfilled)—PCF 740 makes decision

The main idea of this aspect is to indicate the reason why the QoS target(s) cannot be fulfilled. In this aspect, the PCF 740 makes decision.

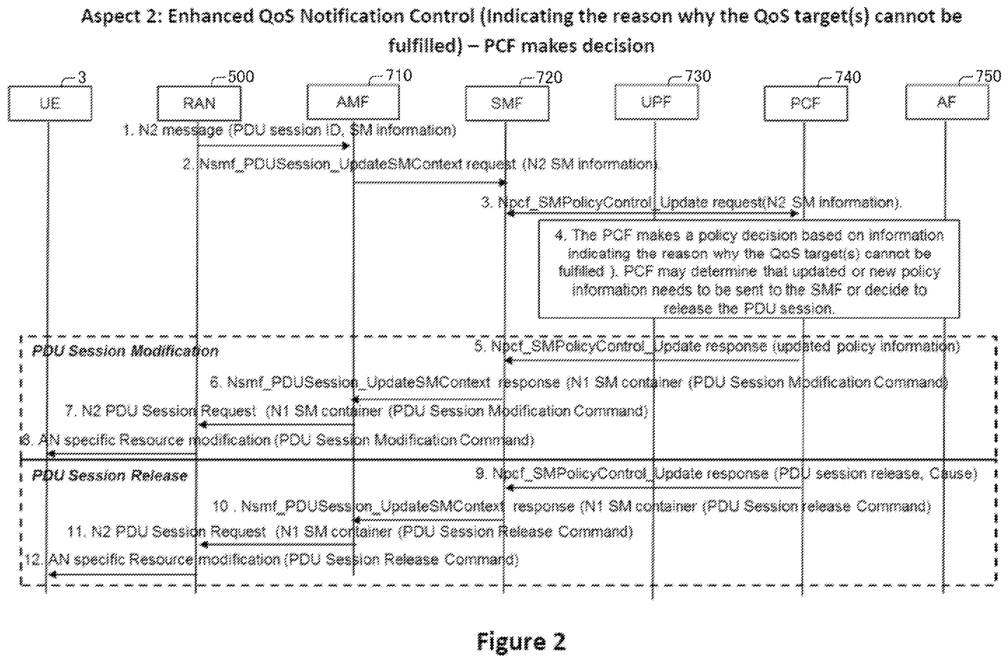

FIG. 2 demonstrates an exemplary procedure for the enhanced QoS notification control (indicating the reason why the QoS target(s) cannot be fulfilled), in which the PCF 740 makes decision. The new parameter(s) (e.g., information indicating the reason why the QoS target(s) cannot be fulfilled), which are not defined in [1] and [2], are introduced for reporting QoS notification control related information to the network.

Step 1. In a case where one or more QoS target for a PDU session cannot be fulfilled, the RAN 500 sends the AMF 710 a N2 message (PDU Session ID, N2 SM information) when the RAN 500 decides the QoS target(s) of the QoS Flow for the PDU session cannot be fulfilled. The N2 SM information includes the QFI (QoS Flow Identifier), indication(s) that the QoS target(s) for that QoS Flow cannot be fulfilled, and information on the reason why the QoS target(s) cannot be fulfilled. It is noted that new parameters are added in a N2 SM information message in the notification control to allow the network, the UE 3 and the AF 750 to know why QoS target(s) cannot be fulfilled. Information indicating why QoS target(s) cannot be fulfilled can be “overload”, “poor radio signal”, and other kinds of reasons that affects whether the QoS target(s) can be fulfilled.

In addition, The N2 SM information may include proposed QoS target information. The proposed QoS target information is set by the RAN 500 to offer an acceptable QoS target to the network. For example, the proposed Guaranteed Flow Bit Rate (GFBR) for DL indicates that a maximum rate of the GFBR for DL that the RAN 500 can accept for the PDU session. Or for another example, the proposed Guaranteed Flow Bit Rate (GFBR) for UL indicates that a maximum rate of the GFBR for UL that the RAN 500 can accept for the PDU session. The proposed QoS target information can be used by the network to make a decision on the new QoS target for the PDU session. Since the RAN 500 guarantees to accept the new QoS target as long as the new QoS target is set less than the one indicated by the proposed QoS target, the following PDU session modification procedure, i.e., step 7 and step 8, has a good chance to be successful. With a successful PDU session modification procedure, the 5GS can continue to provide an application services, ex. V2X application service, with new QoS setting.

Step 2. The AMF 710 invokes the Nsmf_PDUSession_UpdateSMContext request procedure or any other service procedure or sending a message for providing the SMF 720 the N2 SM information. The N2 SM information may be received from the RAN 500 in step 1.

Step 3. The SMF 720 invokes the Npcf_SMPolicyControl_Update request procedure or any other service procedure or sending a message for requesting the PCF 740 to update (by the Npcf_SMPolicyControl_Update request procedure) the SM Policy Association and providing N2 SM information. The N2 SM information may be the N2 SM information received from the AMF 710 in step 2.

Step 4. The PCF 740 makes a policy decision based on the information indicating the reason why QoS target(s) cannot be fulfilled. The PCF 740 may determine that updated or new policy information needs to be sent to the SMF 720 or decide to release the PDU session. It is noted that the PDU session release is not the focus of this description. For example, if the reason indicates jitter is high and delay is within budget, the PCF 740 may instruct the UE 3 to change its buffer size, and may determine that updated or new policy information needs to be sent to the SMF 720. If the reason indicates the radio signal is not good, or the reason indicates PER is high but delay is on target, the network may transmit redundant packets. If the reason why QoS target(s) cannot be fulfilled is “overload”, and the QoS measurement(s) indicate that delay and PER are high, the PCF 740 may instruct the UE 3 to switch the currently used application/service (e.g., video streaming) by the user of the UE 3 to the preferred version of the application/service that has lower QoS requirements (e.g., lower resolution version), and may determine that updated or new policy information needs to be sent to the SMF 720. The proposed QoS target information can be taken into account by the PCF 740 for a policy decision.

In some aspects, if an event which the AF 750 has subscribed to correspond to the report from the SMF 720, the PCF 740 invokes the Npcf_PolicyAuthorization_Notify procedure or any other service procedure or sending a message for reporting the event to the AF 750. New “QoS notification control event notification” is the procedure that the PCF 740 informs the AF 750 by using a Npcf_PolicyAuthorization_Notify message. The QoS notification control event notification may include timestamp(s) of the event and other N2 SM information. In this case, the AF 750 reacts based on information the reason why QoS target(s) cannot be fulfilled and may request the UE 3 to change according to the current QoS measurement. If the reason why QoS target(s) cannot be fulfilled is overload, and the QoS measurement(s) indicate that delay and PER are high, the V2X AF may instruct the UE 3 to switch the currently used application to the preferred version of the application that has lower QoS requirements (e.g., lower level of V2X automation). In this case, the AF 750 may invoke a Npcf_PolicyAuthorization update procedure or any other service procedure or sending a message for requesting the PCF 740 to change policy.

If the PCF's decision is to invoke a PDU session modification procedure, it will carry on Step 5 to Step 8 (where the procedure ends).

If the PCF's decision is to invoke PDU session release procedure, it will carry on Step 9 to Step 12 (i.e., steps 5 to 8 are omitted).

Step 5. [Conditional] The PCF 740 invokes a Npcf_SMPolicyControl_Update response procedure or any other service procedure or sending a message for providing updated policy information about the PDU Session.

Step 6. [Conditional] The SMF 720 responds to the AMF 710 by invoking a Nsmf_PDUSession_UpdateSMContext response procedure or any other service procedure or sending a message for providing the N2 SM information to the RAN 500 and the PDU Session Modification Command to the UE 3. The N2 SM information includes a PDU Session ID, QFI(s), QoS Profile(s), and Session-AMBR. The N1 SM container (PDU Session Modification Command) includes a PDU Session ID, QoS rule(s), QoS rule operation, QoS Flow level QoS parameters if needed for the QoS Flow(s) associated with the QoS rule(s), and Session-AMBR.

Step 7. [Conditional] The AMF 710 sends a N2 PDU Session Request Message with N2 SM information received from the SMF 720 and a NAS message, to the (R)AN 500. The NAS message includes a PDU Session ID, and a N1 SM container (PDU Session Modification Command).

Step 8. [Conditional] The (R)AN 500 may issue the AN specific signalling exchange (AN specific Resource modification) with the UE 3 on resource modification (for example, by using the PDU Session Modification Command).

Step 9. [Conditional] The PCF 740 invokes a Npcf_SMPolicyControl_Update response procedure or any other service procedure or sending a message for requesting the release of the PDU Session with a Cause. The Cause is the associated information, which may be proposed QoS target information cannot be accepted or any other information related to the release of the PDU Session.

Step 10. [Conditional] The SMF 720 responds to the AMF 710 by invoking a Nsmf_PDUSession_UpdateSMContext response procedure or any other service procedure or sending a message for providing the N2 SM information to the (R)AN 500 and the PDU Session Release Command to the UE 3.

Step 11. [Conditional] The AMF 710 sends a N2 Resource Release request (N2 PDU Session Request) Message with N2 SM information received from the SMF 720 and a NAS message to the (R)AN 500. The NAS message includes a PDU Session ID, and a N1 SM container (PDU Session Release Command).

Step 12. [Conditional] The (R)AN 500 may issue the AN specific signalling exchange (AN specific Resource modification) with the UE 3 to release the corresponding AN resources (for example, by using the PDU Session Release Command).

In this aspect, the PCF 740/AF 750 can have a better understanding why QoS target(s) cannot be fulfilled. As its result, the PCF 740/AF 750 can take proper action based on the obtained QoS information and data. Another benefit of this aspect is that if the notification control is triggered, the PDU session can be modified instead of being released, if the PCF 740/AF 750 decides to change the QoS setting.

Aspect 3: Enhanced QoS notification control (Indicating the difference between the current QoS measurement(s) and the QoS target(s))—AF 750 makes decision

The main idea of this aspect is to use the enhanced QoS notification control based on the information on the difference between the current QoS measurement(s) and the QoS target(s)). In this aspect, the AF 750 makes decision.

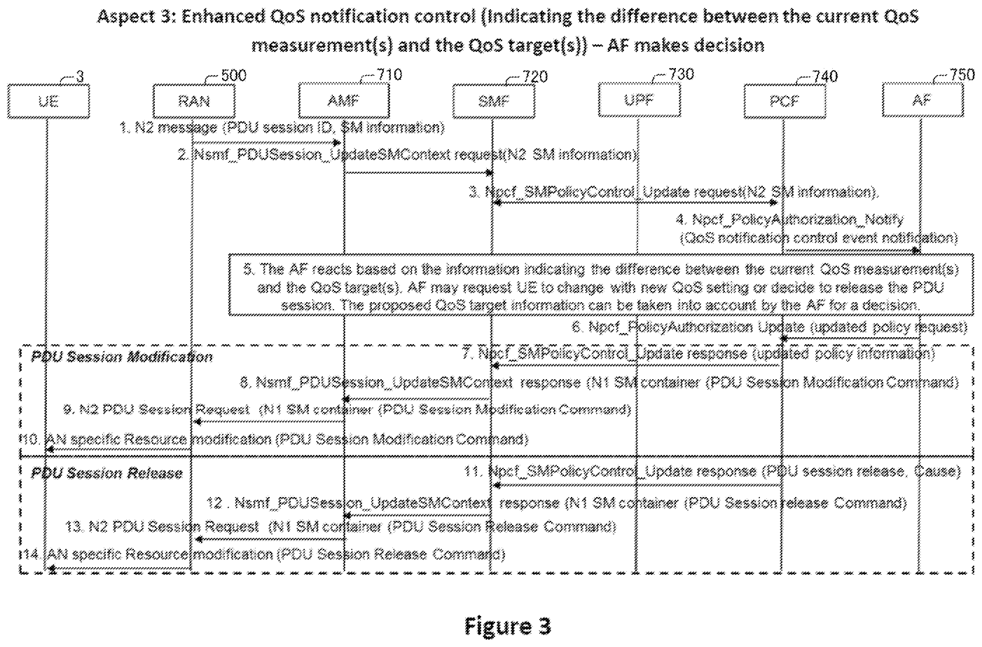

FIG. 3 demonstrates an exemplary procedure for the enhanced QoS notification control (Indicating the difference between the current QoS measurement(s) and the QoS target(s)), in which the AF 750 makes decision. The new parameters (e.g., QoS measurement), which are not defined in [1] and [2], are introduced for reporting QoS notification control related information to the network.

Step 1. In a case where one or more QoS target for a PDU session cannot be fulfilled, the RAN 500 sends the AMF 710 a N2 message (PDU Session ID, N2 SM information) when the RAN 500 decides the QoS target(s) of the QoS Flow for the PDU session cannot be fulfilled. The N2 SM information includes the QFI (QoS Flow Identifier), indication(s) that the QoS target(s) for that QoS Flow cannot be fulfilled, and information indicating the difference between the current QoS measurement(s) and the QoS target(s). In some aspects, the N2 SM information may include at least one of the current QoS measurement of these QoS target(s) for that QoS Flow whose QoS target(s) cannot be fulfilled, indication(s) that the QoS target(s) for that QoS Flow are guaranteed, the current QoS measurement(s) of the QoS target(s) for that QoS Flow whose QoS target(s) are guaranteed. It is noted that new parameters are added in a N2 SM information message in the notification control to allow the network to know which QoS target(s) can be met and which QoS target(s) cannot be met, and how far is the difference between current QoS measurement(s) and QoS target(s).

In addition, The N2 SM information may include proposed QoS target information. The proposed QoS target information is set by the RAN 500 to offer an acceptable QoS target to the network. For example, the proposed Guaranteed Flow Bit Rate (GFBR) for DL indicates that a maximum rate of the GFBR for DL that the RAN 500 can accept for the PDU session. Or for another example, the proposed Guaranteed Flow Bit Rate (GFBR) for UL indicates that a maximum rate of the GFBR for UL that the RAN 500 can accept for the PDU session. The proposed QoS target information can be used by the network to make a decision on the new QoS target for the PDU session. Since the RAN 500 guarantees to accept the new QoS target as long as the new QoS target is set less than the one indicated by the proposed QoS target, the following PDU session modification procedure, i.e., step 9 and step 10, has a good chance to be successful. With a successful PDU session modification procedure, the 5GS can continue to provide an application services, ex. V2X application service, with new QoS setting.

Step 2. The AMF 710 invokes the Nsmf_PDUSession_UpdateSMContext request procedure or any other service procedure or sending a message for providing the SMF 720 the N2 SM information. The N2 SM information may be received from the RAN 500 in step 1.

Step 3. The SMF 720 invokes the Npcf_SMPolicyControl_Update request procedure or any other service procedure or sending a message for requesting the PCF 740 to update (by the Npcf_SMPolicyControl_Update request procedure) the SM Policy Association and providing N2 SM information. The N2 SM information may be the N2 SM information received from the AMF 710 in step 2.

Step 4. When the AF 750 has subscribed to an event that is met due to the report from the SMF 720, the PCF 740 invokes the Npcf_PolicyAuthorization_Notify or any other service procedure or message for reporting the event to the AF 750. New “QoS notification control event notification” are proposed for the PCF 740 to inform the AF 750 by using a Npcf_PolicyAuthorization_Notify message. The QoS notification control event notification includes at least one of timestamp(s) of the event, and N2 SM information. The N2 SM information may be the N2 SM information received from the AMF 710 in step 2.

Step 5. The AF 750 reacts based on the information indicating the difference between the current QoS measurement(s) and the QoS target(s) included in the N2 SM information. The AF 750 may request the UE 3 to change with the new QoS setting or decide to release the PDU session. The proposed QoS target information can be taken into account by the AF 750 for a decision. For example, if a UE 3 uses video streaming service, the network experiences overload and notification control has been triggered. The QoS measurements show that delay and PER are high, the AF 750 may change the currently used video streaming service to lower resolution version. The proposed QoS target information can be taken into account by the AF 750 for new QoS target decision.

Step 6. The AF 750 invokes, sending a Npcf_PolicyAuthorization update message or any other service procedure or sending a message for requesting the PCF 740 to change policy.

If the AF's decision is to invoke a PDU session modification procedure, it will carry on Step 7 to Step 10 (where the procedure ends).

If the AF's decision is to invoke a PDU session release procedure, it will carry on Step 11 to Step 14 (i.e., steps 7 to 10 are omitted).

Step 7. [Conditional] The PCF 740 invokes a Npcf_SMPolicyControl_Update response procedure or any other service procedure or sending a message for providing updated policy information about the PDU Session.

Step 8. [Conditional] The SMF 720 responds to the AMF 710 by invoking a Nsmf_PDUSession_UpdateSMContext response procedure or any other service procedure or sending a message for providing the N2 SM information to the RAN 500 and the PDU Session Modification Command to the UE 3. The N2 SM information includes a PDU Session ID, QFI(s), QoS Profile(s), and Session-AMBR. The N1 SM container (PDU Session Modification Command) includes a PDU Session ID, QoS rule(s), QoS rule operation, QoS Flow level QoS parameters if needed for the QoS Flow(s) associated with the QoS rule(s), and Session-AMBR.

Step 9. [Conditional] The AMF 710 sends a N2 PDU Session Request Message with N2 SM information received from the SMF 720 and a NAS message, to the (R)AN 500. The NAS message includes a PDU Session ID, and a N1 SM container (PDU Session Modification Command).

Step 10. [Conditional] The (R)AN 500 may issue the AN specific signalling exchange (AN specific Resource modification) with the UE 3 on resource modification (for example, using the PDU Session Modification Command).

Step 11. [Conditional] The PCF 740 invokes a Npcf_SMPolicyControl_Update response procedure or any other service procedure or sending a message for requesting the release of the PDU Session with a Cause. The Cause is the associated information, which may be proposed QoS target information cannot be accepted or any other information related to the release of the PDU Session.

Step 12. [Conditional] The SMF 720 responds to the AMF 710 by invoking a Nsmf_PDUSession_UpdateSMContext response procedure or any other service procedure or sending a message for providing the N2 SM information to the RAN 500 and the PDU Session Release Command to the UE 3.

Step 13. [Conditional] The AMF 710 sends a N2 Resource Release request (N2 PDU Session Request) Message with N2 SM information received from the SMF 720 and a NAS message, to the (R)AN 500. The NAS message includes a PDU Session ID, and a N1 SM container (PDU Session Release Command).

Step 14. [Conditional] The (R)AN 500 may issue the AN specific signalling exchange (AN specific Resource modification) with the UE 3 to release the corresponding AN resources (for example, using the PDU Session Release Command).

In this aspect, the AF 750 can have a better understanding on why the notification control is triggered. As its result, the AF 750 can take proper action based on the obtained QoS information and data. Another benefit of this aspect is that if the notification control is triggered, the PDU session can be modified instead of being released, if the PCF 740/AF 750 decides to change the QoS setting.

Aspect 4: Enhanced QoS notification control (Indicating the reason why the QoS target(s) cannot be fulfilled)—AF 750 makes decision

The main idea of this aspect is to indicate the reason why the QoS target(s) cannot be fulfilled. In this aspect, the AF 750 makes decision.

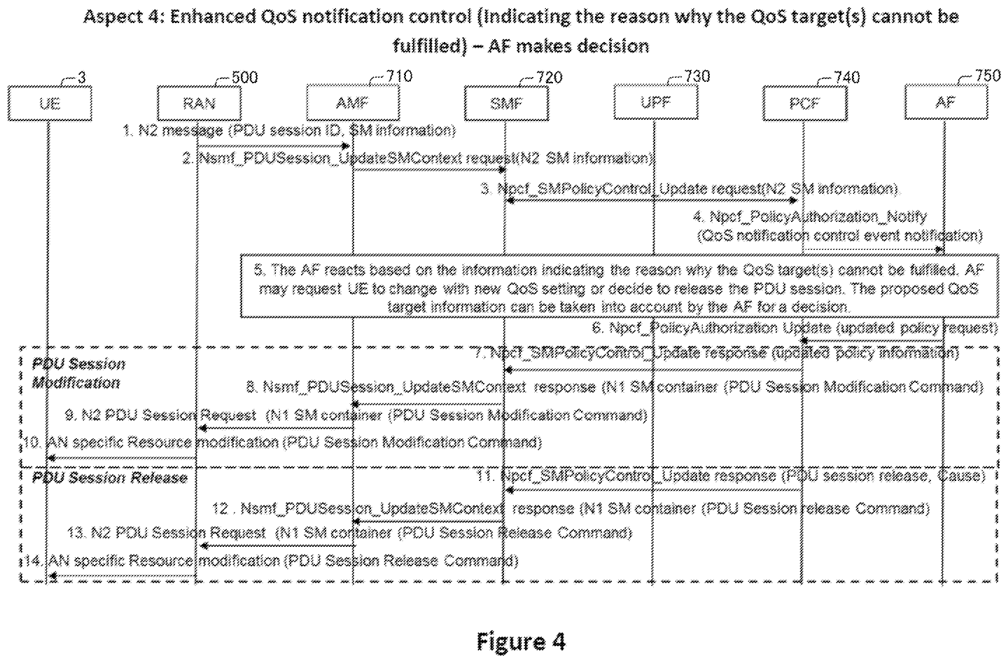

FIG. 4 demonstrates an exemplary procedure for the enhanced QoS notification control based on the information on the reason why the QoS target(s) cannot be fulfilled, in which the AF 750 makes decision. The new parameter(s) (e.g., information indicating the reason why the QoS target(s) cannot be fulfilled), which are not defined in [1] and [2], are introduced for reporting QoS notification control related information to the network.

Step 1. In a case where one or more QoS target for a PDU session cannot be fulfilled, the RAN 500 sends the AMF 710 a N2 message (PDU Session ID, N2 SM information) when the RAN 500 decides the QoS target(s) of the QoS Flow for the PDU session cannot be fulfilled. The N2 SM information includes the QFI (QoS Flow Identifier), indication(s) that the QoS target(s) for that QoS Flow cannot be fulfilled, and information the reason why the QoS target(s) cannot be fulfilled. It is noted that new parameters are added in N2 SM information message in the notification control to allow the network, the UE 3 and the AF 750 to know why QoS target(s) cannot be fulfilled. Information indicating why QoS target(s) cannot be fulfilled can be “overload”, “poor radio signal”, and other kinds of reasons that affects whether the QoS target(s) can be fulfilled.

In addition, The N2 SM information may include proposed QoS target information. The proposed QoS target information is set by the RAN 500 to offer an acceptable QoS target to the network. For example, the proposed Guaranteed Flow Bit Rate (GFBR) for DL indicates that a maximum rate of the GFBR for DL that the RAN 500 can accept for the PDU session. Or for another example, the proposed Guaranteed Flow Bit Rate (GFBR) for UL indicates that a maximum rate of the GFBR for UL that the RAN 500 can accept for the PDU session. The proposed QoS target information can be used by the network to make a decision on the new QoS target for the PDU session. Since the RAN 500 guarantees to accept the new QoS target as long as the new QoS target is set less than the one indicated by the proposed QoS target, the following PDU session modification procedure, i.e., step 9 and step 10, has a good chance to be successful. With a successful PDU session modification procedure, the 5GS can continue to provide an application services, ex. V2X application service, with the new QoS setting.

Step 2. The AMF 710 invokes the Nsmf_PDUSession_UpdateSMContext request procedure or any other service procedure or sending a message for providing the SMF 720 the N2 SM information. The N2 SM information may be received from the RAN 500 in step 1.

Step 3. The SMF 720 invokes the Npcf_SMPolicyControl_Update request procedure or any other service procedure or sending a message for requesting the PCF 740 to update (by the Npcf_SMPolicyControl_Update request procedure) the SM Policy Association and providing N2 SM information. The N2 SM information may be the N2 SM information received from the AMF 710 in step 2.

Step 4. When the AF 750 has subscribed to an event that is met due to the report from the SMF 720, the PCF 740 invokes the Npcf_PolicyAuthorization_Notify or any other service procedure or message for reporting the event to the AF 750. New “QoS notification control event notification” are proposed for the PCF 740 to inform the AF 750 by using a Npcf_PolicyAuthorization_Notify message. The QoS notification control event notification includes at least one of timestamp(s) of the event, and N2 SM information. The N2 SM information may be the N2 SM information received from the AMF 710 in step 2.

Step 5. The AF 750 reacts based on the information indicating the reason why the QoS target(s) cannot be fulfilled included in the N2 SM information. The AF 750 may request the UE 3 to change with the new QoS setting or decide to release the PDU session. The proposed QoS target information can be taken into account by the AF 750 for a decision. For example, if a UE 3 uses video streaming service, the network experiences overload and notification control has been triggered. The QoS measurements show that delay and PER are high, the AF 750 may change the currently used video streaming service to lower resolution version. The proposed QoS target information can be taken into account by the AF 750 for the new QoS target decision.

Step 6. The AF 750 invokes, sending a Npcf_PolicyAuthorization update message or any other service procedure or sending a message for requesting the PCF 740 to change policy.

If the AF's decision is to invoke a PDU session modification procedure, it will carry on Step 7 to Step 10 (where the procedure ends).

If the AF's decision is to invoke a PDU session release procedure, it will carry on Step 11 to Step 14 (i.e., steps 7 to 10 are omitted).

Step 7. [Conditional] The PCF 740 invokes a Npcf_SMPolicyControl_Update response procedure or any other service procedure or sending a message for providing updated policy information about the PDU Session.

Step 8. [Conditional] The SMF 720 responds to the AMF 710 by invoking a Nsmf_PDUSession_UpdateSMContext response procedure or any other service procedure or sending a message for providing the N2 SM information to the RAN 500 and the PDU Session Modification Command to the UE 3. The N2 SM information includes a PDU Session ID, QFI(s), QoS Profile(s), and Session-AMBR. The N1 SM container (PDU Session Modification Command) includes a PDU Session ID, QoS rule(s), QoS rule operation, QoS Flow level QoS parameters if needed for the QoS Flow(s) associated with the QoS rule(s), and Session-AMBR.

Step 9. [Conditional] The AMF 710 sends a N2 PDU Session Request Message with N2 SM information received from the SMF 720 and a NAS message to the (R)AN 500. The NAS message includes a PDU Session ID, and a N1 SM container (PDU Session Modification Command).

Step 10. [Conditional] The (R)AN 500 may issue the AN specific signalling exchange (AN specific Resource modification) with the UE 3 on resource modification (for example, using the PDU Session Modification Command).

Step 11. [Conditional] The PCF 740 invokes a Npcf_SMPolicyControl_Update response procedure or any other service procedure or sending a message for requesting the release of the PDU Session with a Cause. The Cause is the associated information, which may be proposed QoS target information cannot be accepted or any other information related to the release of the PDU Session.

Step 12. [Conditional] The SMF 720 responds to the AMF 710 by invoking a Nsmf_PDUSession_UpdateSMContext response procedure or any other service procedure or sending a message for providing the N2 SM information to the RAN 500 and the PDU Session Release Command to the UE 3.

Step 13. [Conditional] The AMF 710 sends a N2 Resource Release request (N2 PDU Session Request) Message with N2 SM information received from the SMF 720 and a NAS message, to the (R)AN 500. The NAS message includes a PDU Session ID, and a N1 SM container (PDU Session Release Command).

Step 14. [Conditional] The (R)AN 500 may issue the AN specific signalling exchange (AN specific Resource modification) with the UE 3 to release the corresponding AN resources(for example, using the PDU Session Release Command).

In this aspect, the AF 750 can have a better understanding why QoS target(s) cannot be fulfilled. As its result, the AF 750 can take proper action based on the obtained QoS information and data. Another benefit of this aspect is that if the notification control is triggered, the PDU session can be modified instead of being released, if the PCF 740/AF 750 decides to change the QoS setting.

### SUMMARY

Beneficially, the above described aspects include, although they are not limited to, one or more of the following functionalities:

1) After notification control has been triggered, network can update the policy either by itself or based on AF's request. PDU session(s) can be adjusted instead of being released, which is defined in the current 3GPP specifications.

2) New parameter “information on why QoS target(s) cannot be fulfilled” is proposed in the notification control, which lets the network and the AF 750 know what causes the unfulfilled QoS target(s).

3) New element “QoS measurement” is proposed in the notification control, which let the network and the AF 750 know not only which QoS target cannot be guaranteed and which can be guaranteed, but also know how far between the current QoS measurement reading and QoS target.

4) Based on whether QoS target(s) can be guaranteed or not, the difference between current QoS measurement reading and QoS target for each QoS parameter, and information on why QoS target(s) cannot be fulfilled, the network and the AF 750 make proper response to QoS degradation.

5) New parameter “proposed QoS target information” is proposed. The proposed QoS target information is set by the RAN 500 to offer an acceptable QoS target to the network, and can be used by the network to make a decision on new QoS target for the PDU session. Since the RAN 500 guarantees to accept new QoS target as long as new QoS target is set less than the one indicated by the proposed QoS target, the following PDU session modification procedure has a good chance to be successful. With a successful PDU session modification procedure, the 5GS can continue to provide an application services with new QoS setting.

In order to provide these functionalities, the above aspects describe exemplary methods comprising (at least some of) the following steps:

1) During a PDU session, when one or more QoS target cannot be guaranteed, notification control is triggered, the RAN 500 informs the AMF 710 N2 SM information includes the QFI, indication(s) that the QoS target(s) for that QoS Flow cannot be fulfilled, and at least one of the current QoS measurement of these QoS target(s) for that QoS Flow cannot be fulfilled, indication(s) that the QoS target(s) for that QoS Flow can be guaranteed, the current QoS measurement of these QoS target(s) for that QoS Flow can be guaranteed, and information on why QoS target(s) cannot be fulfilled. In addition, The N2 SM information may include proposed QoS target information. The proposed QoS target information is set by the RAN 500 to offer an acceptable QoS target to the network.

2) The AMF 710 invokes the Nsmf_PDUSession_UpdateSMContext with N2 SM information

3) The SMF 720 requests the PCF 740 to update the SM Policy Association and provides N2 SM information

4) The PCF 740/AF 750 makes a policy decision based on the QoS target indicator, QoS target, QoS measurement, and information on why QoS target(s) cannot be fulfilled and may determine that updated or new policy information needs to be sent to the SMF 720.

### Benefits

Currently, the RAN nodes only notify a core network that a QoS target cannot be fulfilled. Since it is only a notification, it is not possible for the core network to know how to react.

The main advantage of this application is that the RAN 500 provides an associated information to the core network on why the notification control is triggered. With the associated information, the core network can take an appropriate action.

One possible action of the core network is the update of new QoS setting for a PDU session appropriately in case that requested QoS cannot be fulfilled in the RAN 500. In this way, a lower QoS is accepted and the PDU session can continue.

Another possible action for the core network is to release the PDU session by referring to the associated information.

Additionally, the PDU session modification procedure to be taken after the RAN notification always gets successful since the core network understands the RAN 500 situation in advance.

### System Overview

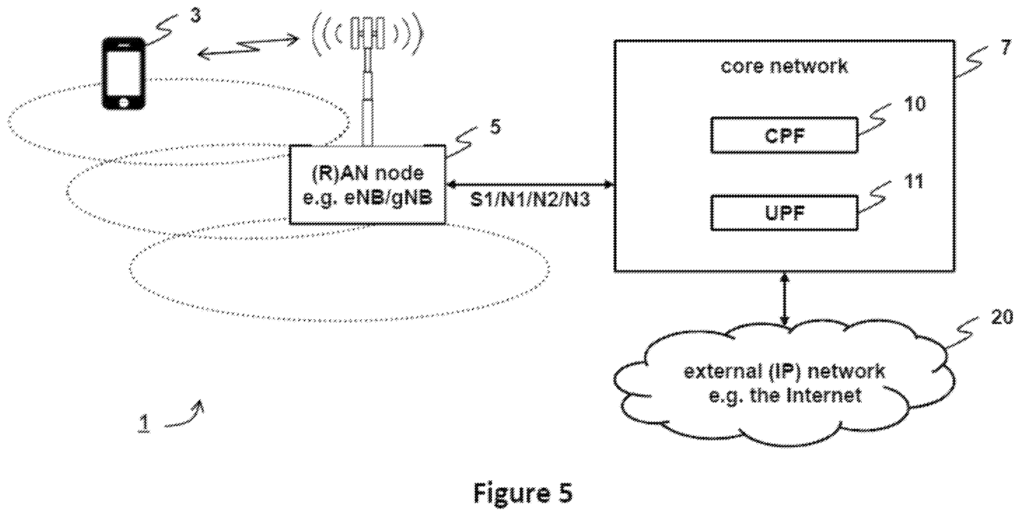

FIG. 5 schematically illustrates a mobile (cellular or wireless) telecommunication system 1 to which the above aspects and examples are applicable.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN 500. As those skilled in the art will appreciate, whilst one mobile device 3 and one base station 5 are shown in FIG. 5 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA/4G protocols may be referred to as an ‘eNB’ and a base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5 is also connected to the core network nodes 10, 11 via an appropriate interface (such as the so-called ‘S1’, ‘N1’, ‘N2’, ‘N3’ interface, and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) 10 and user plane functions (UPFs) 11. Such control plane functions (and user plane functions) may provide the functionality of the AMF 710, the SMF 720, the UPF 730, the PCF 740, and/or the AF 750 discussed in the above aspects.

From the core network 7, connection to an external IP network 20 (such as the Internet) is also provided.

The components of this system 1 are configured to perform the above described aspects.

### User equipment (UE)

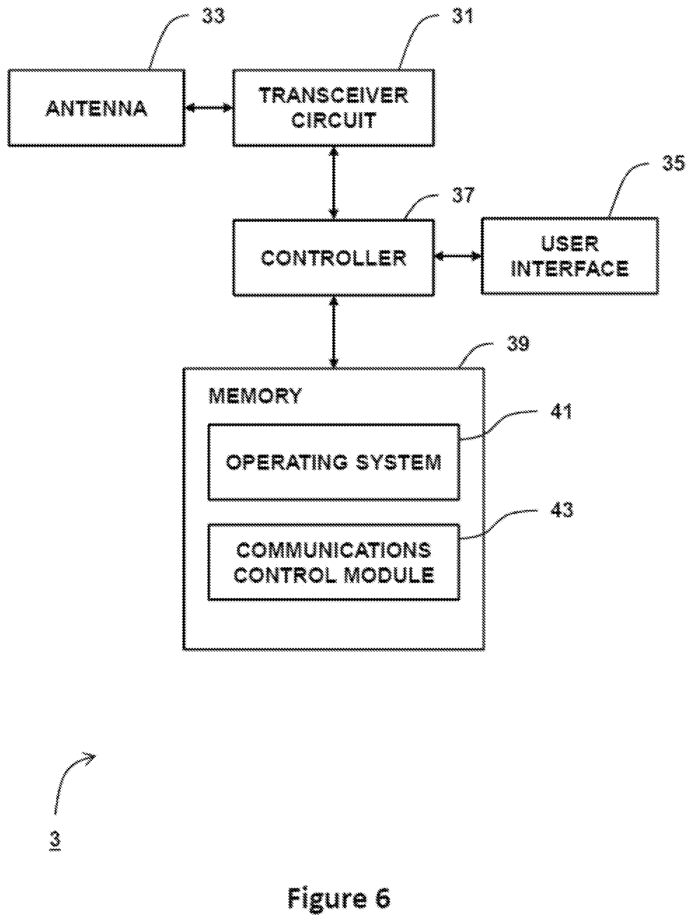

FIG. 6 is a block diagram illustrating, in more detail, the main components of the UE (mobile device 3) shown in FIG. 5. As shown, the UE 3 includes a transceiver circuit 31 which is operable to transmit signals to and to receive signals from the connected node(s) via one or more antenna 33. Although not necessarily shown, the UE will of course have all the usual functionality of a conventional mobile device (such as a user interface 35) and this may be provided by any one or any combination of hardware, software and firmware, as appropriate. A controller 37 controls the operation of the UE in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/ sending/receiving) signalling messages, including uplink/downlink data packets, between the UE 3 and other nodes (e.g., (R)AN nodes 5 and core network nodes 10, 11), in accordance with any one of the above described aspects.

### (R)AN Node

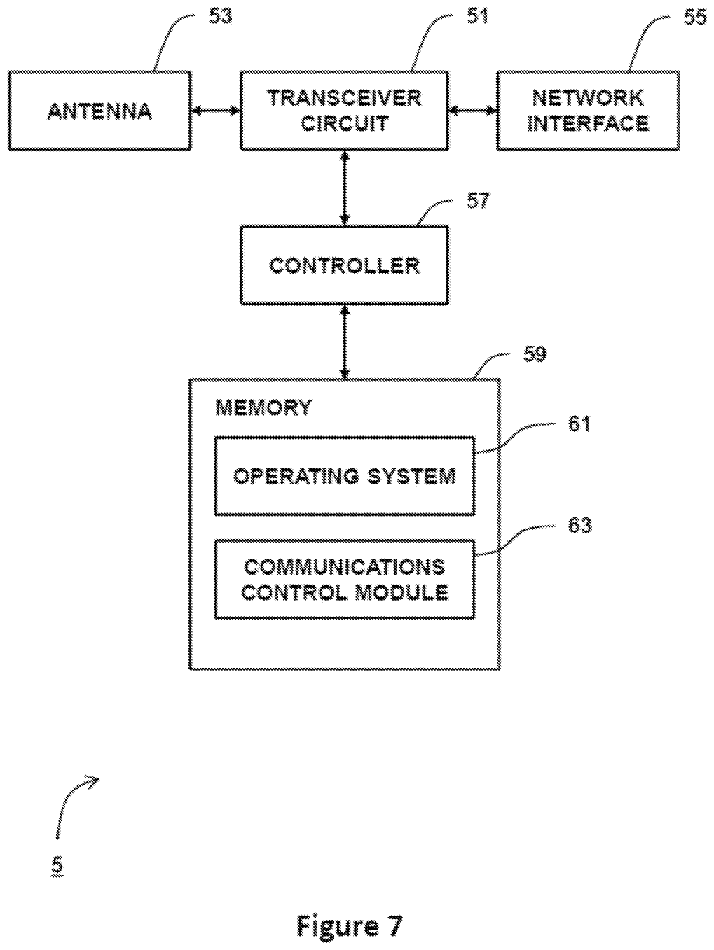

FIG. 7 is a block diagram illustrating, in more detail, the main components of an exemplary (R)AN node 5 (base station 5) shown in FIG. 5. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station-base station interface (such as X2/Xn) and an appropriate base station-core network interface (such as S1/N1/N2 /N3). A controller 57 controls the operation of the (R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63. The communications control module 63 is responsible for handling (generating/sending/receiving) signalling between the (R)AN node 5 and other nodes, such as the UE 3 and the core network nodes 10, 11/network elements. Such signaling includes appropriately formatted messages (and information elements thereof) in accordance with any one of the above described aspects.

### Core Network Node

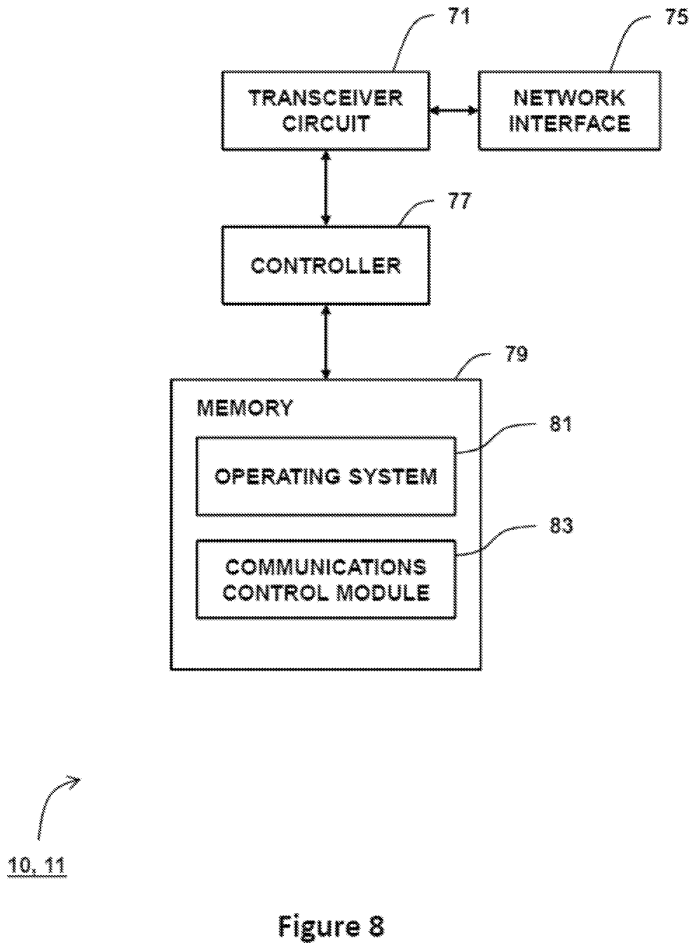

FIG. 8 is a block diagram illustrating, in more detail, the main components of a generic core network node (network element or function) 10, 11 shown in FIG. 5, such as the AMF 710, the SMF 720, the UPF 730, the PCF 740, and the AF 750. It will be appreciated that this block diagram may also apply to network nodes outside the core network 7, e.g., an AF external to the core network 7. As shown, the core network node 10, 11 includes a transceiver circuit 71 which is operable to transmit signals to and to receive signals from other nodes (including the UE 3 and the (R)AN node 5) via a network interface 75. A controller 77 controls the operation of the core network node 10, 11 in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/ receiving) signaling between the core network node 10, 11 and other nodes, such as the UE 3, (R)AN node 5, and other core network nodes 10, 11. Such signaling includes appropriately formatted messages in accordance with any one of the above described aspects.

### Modifications and Alternatives

Detailed aspects have been described above. As those skilled in the art will appreciate, a number of modifications and alternatives can be made to the above aspects whilst still benefiting from the inventions embodied therein. By way of illustration only a number of these alternatives and modifications will now be described.

In the above description, the UE, the (R)AN node, and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g., control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The above aspects are also applicable to ‘non-mobile’ or generally stationary user equipment.

Various other modifications will be apparent to those skilled in the art and will not be described in further detail here.

### CITATION LIST

### Non Patent Literature

[NPD 1] 3GPP TS 23.501 V15.4.0

[NPD 2] 3GPP TS 23.502 V15.4.0

[NPD 3] 3GPP TS 23.503 V15.4.0

[NPD 4] 3GPP TR 23.786 V1.0.0

This application is based upon and claims the benefit of priority from European patent application No. 19151053.6, filed on Jan. 9, 2019, the disclosure of which is incorporated herein in its entirely by reference.

### REFERENCE SIGNS LIST

1 telecommunication system

3 UE

31 transceiver circuit

33 antenna

35 user interface

37 controller

39 memory

41 operating system

43 communications control module

5 base station

51 transceiver circuit

53 antenna

55 network interface

57 controller

59 memory

61 operating system

63 communications control module

500 RAN

7 core network

71 transceiver circuit

75 network interface

77 controller

79 memory

81 operating system

83 communications control module

710 AMF

720 SMF

730 UPF

740 PCF

750 AF

10 CPF

11 UPF

20 external IP network

What is claimed is:

1-7. (canceled)

8. A policy control function node comprising:
a memory storing instructions; and
at least one processor configured to process the instructions to:
receive a notification message including information indicating that at least one Quality of Service (QoS) target for a Protocol Data Unit (PDU) session cannot be fulfilled by an access network node and information indicating at least one first alternative QoS information that the access network node can guarantee, from the access network node via a session management node;
forward the notification message to an application function node to cause the application function node to decide a new QoS requirement taking the first alternative QoS information into account; and
change QoS parameter based on a policy rule for the PDU session.

9. The policy control function node according to claim 8, wherein the at least one processor is further configured to process the instructions to:
receive a request to subscribe to send the notification message, from the application function node before sending the notification message.

10-16. (canceled)

17. A method for a policy control function node, comprising:
receiving a notification message including information indicating that at least one Quality of Service (QoS) target for a Protocol Data Unit (PDU) session cannot be fulfilled by an access network node and information indicating at least one first alternative QoS information that the access network node can guarantee, from the access network node via a session management node;
forwarding the notification message to an application function node to cause the application function node to decide a new QoS requirement taking the first alternative QoS information into account; and
changing QoS parameter based on a policy rule for the PDU session.

18. The method according to claim 17, further comprising:
receiving a request to subscribe to send the notification message, from the application function node before sending the notification message.

19. An application function node comprising:
a memory storing instructions; and
at least one processor configured to process the instructions to:
receive a notification message including information indicating that at least one Quality of Service (QoS) target for a Protocol Data Unit (PDU) session cannot be fulfilled by an access network node, and information indicating at least one first alternative QoS information that the access network node can guarantee, from the access network node via a session management function node and a policy control function node;
decide a new QoS requirement taking the first alternative QoS information into account; and
share the new QoS requirement with a user equipment (UE) via an application layer.

20. The application function node according to claim 19, wherein the at least one processor is further configured to process the instructions to:
send a request to subscribe to receive the notification message, to the policy control function node before receiving the notification message.

21. A method for an application function node, comprising:
receiving a notification message including information indicating that at least one Quality of Service (QoS) target for a Protocol Data Unit (PDU) session cannot be fulfilled by an access network node, and information indicating at least one first alternative QoS information that the access network can guarantee, from the access network node via a session management function node and a policy control function node;
deciding a new QoS requirement taking the first alternative QoS information into account; and
sharing the new QoS requirement with a user equipment (UE) via an application layer.

22. The method according to claim 21, further comprising:
sending a request to subscribe to receive the notification message, to the policy control function node before receiving the notification message.
